(19) United States
(12) Patent Application Publication
(10) Pub. No.: US 2012/0041666 A1
(43) Pub. Date: Feb. 16, 2012

(54) METHOD FOR CONTROLLING AN INTERNAL COMBUSTION ENGINE

(75) Inventors: Helerson Kemmer, Vaihingen (DE); Dirk Hofmann, Stuttgart (DE); Jens Wagner, Stuttgart (DE); Walter Maeurer, Korntal-Muenchingen (DE)

(73) Assignee: ROBERT BOSCH GMBH, STUTTGART (DE)

(21) Appl. No.: 12/865,052

(22) PCT Filed: Jan. 20, 2009
(86) PCT No.: PCT/EP09/50595

§ 371 Date: Nov. 4, 2011

(30) Foreign Application Priority Data
Jan. 28, 2008 (DE) 10 2008 006 327.4

(51) Int. Cl. F02D 41/30

(52) U.S. Cl. 701/104

(57) ABSTRACT

A method is disclosed for controlling an internal combustion engine having a plurality of fuel injectors, each for injecting fuel into one combustion chamber of the internal combustion engine, comprising the following steps: activating the fuel injectors in order to supply a first target total fuel quantity using a first injection strategy, ascertaining a first actual total fuel quantity injected during the activation using the first injection strategy, activating the fuel injectors in order to supply a second target total fuel quantity using a second injection strategy, wherein at least one of said fuel injectors being activated differently from said first injection strategy during said second injection strategy, ascertaining a second actual total fuel quantity injected during the activation using the second injection strategy, and determining an operating behavior of at least one of the fuel injectors as a function of the first actual total fuel quantity and the second actual total fuel quantity.

The present invention relates to a method for controlling an internal combustion engine having a plurality of fuel injectors, each for injecting fuel into one combustion chamber of the internal combustion engine, comprising the following steps: activating the fuel injectors in order to supply a first target total fuel quantity, ascertaining a first actual total fuel quantity injected during the activation and determining an operating behavior of at least one of the fuel injectors as a function of the actual total fuel quantity. The invention furthermore relates to a device for carrying out such a method and a corresponding computer program.

In internal combustion engines having a plurality of combustion chambers, which are supplied with fuel via fuel injectors, it is necessary for compliance with emissions standards and for avoidance of uneven running of the internal combustion engine to individually monitor the fuel quantities injected in each case by the individual fuel injectors, i.e. to perform a combustion chamber-specific monitoring. In this respect various methods are known from the technical field. It is, for example, known how to detect the uneven running of the internal combustion engine and to change the activation of the individual fuel injectors, respectively individual combustion chambers, such that the correct quantities of fuel are injected. A further option is to acquire the lambda value for each individual combustion chamber, for example by using a plurality of lambda probes or by a sufficient high-frequency scanning of the signal of a lambda probe, which ascertains the lambda value of the composite and aggregate exhaust gas of the individual combustion chambers of the internal combustion engine.

The depicted and described methods and devices have various disadvantages and are therefore partially imprecise. The use of a single lambda probe, which analyses the total exhaust gas, is as a result imprecise because the exhaust gases of the individual combustion chambers partially mix. Other methods or devices are complex. For example, providing in each case a lambda probe for every combustion chamber is expensive.

### SUMMARY

It is therefore the aim of the invention to improve the aforementioned devices and methods from the technical field. In particular a simple and cost effective option shall be created to monitor the characteristics of the fuel injectors in an injector-specific manner during the operation of the internal combustion engine.

The aim is met by a method for controlling an internal combustion engine having a plurality of fuel injectors, each for injecting fuel into one combustion chamber of the internal combustion engine, comprising the following steps: activating the fuel injectors in order to supply a first target total fuel quantity using a first injection strategy, ascertaining a first actual total fuel quantity injected during the activation using the first injection strategy, activating the fuel injectors in order to supply a second target total fuel quantity using a second injection strategy, wherein at least one of said fuel injectors is activated differently from said first injection strategy during said second injection strategy, ascertaining a second actual total fuel quantity injected during the activation using the second injection strategy and determining an operating behavior of at least one of the fuel injectors as a function of the first actual total fuel quantity and the second actual total fuel quantity. In so doing, the words target total fuel quantity and actual total fuel quantity denote in each case preferably fuel quantities, which shall be injected, respectively actually are injected, during a specified number of operating cycles. This corresponds to a volume flow or mass flow of fuel related to one operating cycle. Determining the actual fuel quantities injected is to be understood in general terms so that methods of determination are also included hereunder, which ascertain parameters that only indirectly have something to do with the fuel quantity, for example ascertaining the air flow through the combustion chambers at a known lambda value of the exhaust gas. The specific operating behavior of at least one of the fuel injectors is likewise to be understood in general terms. It is particularly to be understood hereunder to what extent the respective fuel injector follows a set point on the part of a control system of the internal combustion engine. In so doing it is to be taken into account that fuel injectors can display a deviation in the fuel quantity injected in each case with respect to a fuel quantity requested by the control system over the service life of an internal combustion engine. This can result, for example, due to wear. Furthermore it is possible that fuel injectors become inoperable during the service life of an internal combustion engine. That is to say they no longer have tolerable or correctable functional impairments so that they have to be replaced to insure a proper operation of the internal combustion engine. The determination of the operating behavior of said fuel injectors preferably occurs as a function of the first actual total fuel quantity or the second actual total fuel quantity in each case in relation to the respective target fuel quantities. In this way a check can not only be made to determine how an individual injector or a plurality of injectors behaves relative to the other injectors, but a check can also be made to determine whether all of the injectors together correctly supply the predetermined total fuel quantity (target total fuel quantity). Furthermore, an additional parameter for checking the operating behavior of the fuel injectors is thereby established.

The first target total fuel quantity is advantageously equal to the second target total fuel quantity. This assures a particularly simple check or determination of the operating behavior of the fuel injectors because such a check is possible at the same operating point of the internal combustion engine so that the two injection strategies can be carried out in a continuous sequence. In this way the influence of ulterior disturbance variables can be minimized.

The operability of at least one of fuel injectors is preferably determined as a function of the specified operating behavior of the fuel injector. It is therefore possible to detect a defective fuel injector, in which a correct supply of fuel cannot be achieved even by a change in the activation, and to make a corresponding entry into a service ledger. A corresponding warning can furthermore result to the driver of the motor vehicle, wherein the internal combustion engine is installed.

An adaptation of an activation parameter is preferably carried out for the at least one fuel injector as a function of the specific operating behavior. Said adaptation is especially preferred in the event of the activation parameters being adapted for all of the fuel injectors of the internal combustion engine. Said adaptation does not necessarily have to include a change in all of the activation parameters but only a change in specific activation parameters so that the operating behaviors of the fuel injectors are compatible with one another. Said adaptation is preferred in the event of an activation parameter being changed, which is a characteristic factor in determining how much fuel flows through the opened fuel injector when a specific activation occurs under certain boundary conditions. Furthermore, said adaptation is preferred to influence an activation parameter, which relates to a connection between an injector opening or closing time and activation.

When the second injector strategy is used, at least both fuel injectors having in each case a different injector fuel quantity requirement with respect to the first injection strategy are advantageously activated. This causes a so-called trimming of the fuel quantity allocation. Said trimming preferably occurs when the target total fuel quantity is constant so that, for example, in a four cylinder engine three fuel injectors having a smaller fuel quantity requirement are activated and the fourth fuel injector having a correspondingly increased fuel quantity requirement is activated. In so doing, the total fuel quantity requested by the control system remains the same. Other trimmings are thereby also possible beside the one mentioned by way of example. In connection with examples of embodiment of the invention, additional possible trimmings are mentioned in this application, which are however only used by way of example. Within the scope of the trimming of the fuel quantity allocation, a system of equations can be created in connection with the injected actual fuel quantities that were ascertained. In so doing, it is possible to carry out an unambiguous determination whether the individual fuel injectors actually supply the injection quantities required in each case, said determination being applied to each injector even in internal combustion engines with numerous, i.e. four or more fuel injectors for four or more combustion chambers. Within the scope of the invention, only one correspondingly increased number of trimming models or different injection strategies is thereby to be used.

When using the second injection strategy, at least one of the fuel injectors having a different number of injector openings for one operating cycle of the internal combustion engine with respect to the first injection strategy is preferably activated. This can, for example, mean that when using the first injection strategy all of the injectors can be activated such that they in each case open and close again only once during an operating cycle in order to supply the required fuel quantity; and when using the second injection strategy one of a total of four fuel injectors is activated in such a manner that this injector performs two individual injections per operating cycle. In so doing, an identical fuel quantity for one injection is preferably allocated over two partial injections. Any other number of individual injections is likewise possible.

A signal of a lambda probe of the internal combustion engine is preferably evaluated to ascertain the actual fuel quantities. The actual fuel quantities are the first actual fuel quantity and the second actual fuel quantity. The lambda probe of the internal combustion engine preferably measures the stoichiometric ratio of the exhaust gas so that the actual fuel quantities, which are injected and combusted by the internal combustion engine, can be suggested in a manner known per se from an item of information about the air throughput through the internal combustion engine and from a signal of the lambda probe. The advantage is that a lambda probe already present in the internal combustion engine can be used to carry out the method.

A plurality of activations is in each case preferably carried out using the first injection strategy or the second injection strategy at different operating points of the internal combustion engine. This means, for example, that a determination of the operating behavior of one or a plurality of injectors is carried out at a specific operating point of the internal combustion engine using the first injection strategy and the second injection strategy; and the method is again carried out using the first or the second injection strategy at a different operating point of the internal combustion engine. The method can, for example, be carried out for a rich operating point, i.e. in the case of excess fuel, and for a lean operating point, i.e. in the case of excess air, in order to subsequently average the results of these two cycles. Other possible variations to the operating point are the rotational speed of the internal combustion engine or the throttle valve position. These offer the advantage of a more accurate determination of deviations in the supply accuracy of individual fuel injectors.

The method is advantageously carried out with at least two different injection strategies, wherein at least two actual total fuel quantities are ascertained. It is, for example, possible to carry out the method with three injection strategies for a four cylinder engine, wherein three actual total fuel quantities are ascertained. A system of equations is created from this, with which the control parameters for the individual fuel injectors are individually adapted such that all of the fuel injectors inject the same fuel quantity when a specific fuel quantity is required. Aside from this, it can likewise be found out from the determination of the lambda value by the lambda probe whether the actual total fuel quantity corresponds to the target total fuel quantity so that an adaptation can also mutually occur across all of the fuel injectors. In so doing, four equations are available for the system of equations in the circumstance of four combustion chambers and fuel injectors. This is, for example, accordingly possible for six combustion chambers and six fuel injectors by at least five different injection strategies being consecutively run with the same target total fuel quantity and subsequently the respective actual total quantities being ascertained. The invention does not rule out that over-determined systems of equation are created, wherein the corrections for the activation parameters are then ascertained by averaging procedures, which can also be weighted.

A further independent subject matter of the invention is a device, particularly a control unit or an internal combustion engine, which is designed for carrying out a method according to the characteristics described above or according to the characteristics described in the embodiments.

An additional independent subject matter of the invention is a computer program with a program code for carrying out a corresponding method.

### BRIEF DESCRIPTION OF THE DRAWINGS

An example of embodiment of the present invention is subsequently explained in detail using the accompanying drawings. The following are thereby shown:

FIG. 1 shows a fuel supply system and an internal combustion engine, with which methods according to the invention can be carried out, in schematic depiction;

FIG. 2 shows schematically a first form of embodiment of a method according to the invention;

FIG. 3 shows schematically a second form of embodiment of a method according to the invention; and

FIG. 4 shows schematically in a diagram a further method according to the invention.

### DETAILED DESCRIPTION

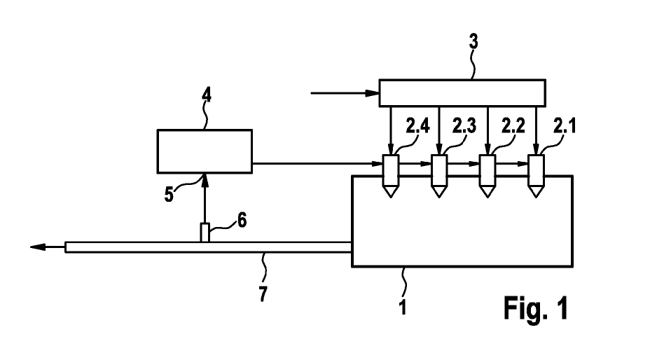

In FIG. 1 an internal combustion engine 1 is schematically depicted, which has four combustion chambers (not shown) available, which are supplied with fuel via four fuel injectors 2.1, 2.2, 2.3, and 2.4. A high pressure accumulator 3, which is supplied with fuel by a tank via a low pressure pump (not shown), is disposed upstream of the fuel injectors 2.1, 2.2, 2.3 and 2.4. The fuel injectors 2.1, 2.2, 2.3 and 2.4 are activated by a control unit 4. The control unit 4 comprises besides other signal inputs and signal outputs a signal input 5, via which a signal of a lambda sensor 6 is fed into the control unit 4. The lambda sensor 6 measures the lambda value of the exhaust gas of the internal combustion engine 1. To this end the lambda sensor 6 is disposed in an exhaust line 7, which carries the exhaust gas of the internal combustion engine 1.

Different embodiments of the invention are explained below with the aid of the flow diagrams and the system shown in FIG. 1.

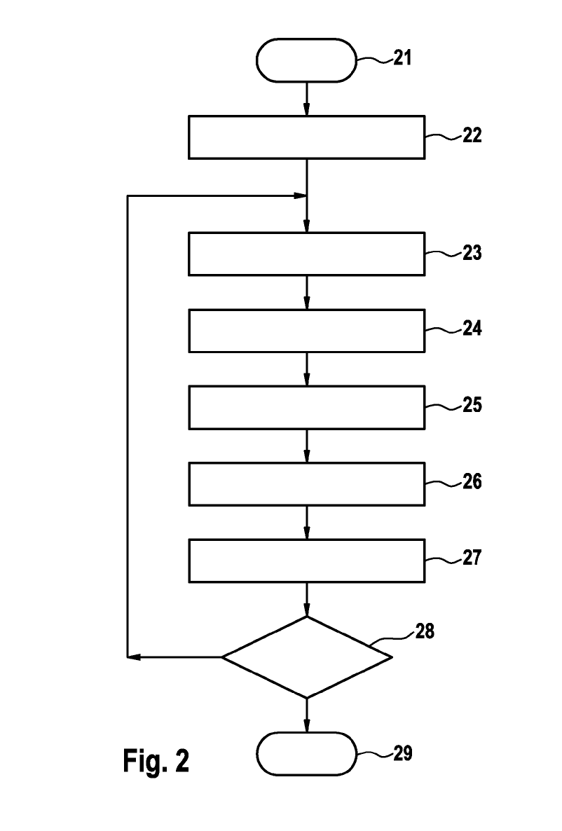

In FIG. 2 a first preferred embodiment of the invention is schematically depicted in a flow diagram. The method according to the invention of FIG. 2 starts with step 21. The start-up of the method according to the invention can routinely be triggered as a function of an acquired mileage in kilometers of a motor vehicle, which is driven by the internal combustion engine. A method according to the invention can also alternatively or additionally be triggered in fixed time intervals or in the event of the system detecting with the aid of other parameters of the internal combustion engine that possibly a malfunction is present in the supply of fuel through one of the fuel injectors 2.

In a subsequent step 22, a fuel injector counter is set to 1. Then the method enters into a loop. The first step in the loop is step 23, whereat all of the fuel injectors are initially activated with the same injection quantity requirement. That means the fuel injectors are activated in step 23 such that they deliver the same fuel quantity as far as that is possible. This corresponds to the first injection strategy. Moreover, a lambda value of 1 is adjusted in the exhaust gas via a throttle valve of the internal combustion engine.

In a subsequent step 24, the same target total fuel quantity is required of the fuel injectors as during the previously implemented step 23. The fuel injectors are, however, not all activated in step 24 with the same injector-specific fuel quantity requirement. On the contrary, the fuel injectors are activated in step 24 with a trimmed quantity requirement. This is one of the possible two injection strategies. Numerous different injection strategies, of which only several are mentioned by way of example in this application, exist for the trimmed fuel quantity requirement when activating the fuel injectors. An injection strategy for trimming the fuel quantity requirement is presented as an example in the method of FIG. 2.

The fuel injectors are activated in step 24 such that the first fuel injector 2.1 of FIG. 1 is activated with a fuel quantity requirement, which is increased by x, and the other fuel injectors 2.2, 2.3, and 2.4 of FIG. 1 are activated with a fuel quantity requirement, which is reduced by x/3. This can be expressed in vector notation by the following:

(+x, −x/3, −x/3, −x/3).

The values of the vector thereby denote the trimming of the respective fuel injector in the sequence of the fuel injectors: 2.1, 2.2, 2.3 and 2.4 of FIG. 1.

The lambda value of the exhaust gas is in turn subsequently measured in step 25. When the activation parameters for the fuel injectors are correctly adjusted, said lambda value would likewise have to be equal to 1 after trimming because the same target total fuel quantity is specified as in step 23. However in the event that the first fuel injector 2.1 shows a greater increase in the relationship of the “required fuel quantity” versus the “supplied fuel quantity”, the lambda value is not equal to 1 because a disproportionally enlarged fuel quantity is actually supplied as a result of the fuel quantity requirement being increased by x in the fuel injector 2.1. This is brought about by the too large of an increase in the relationship mentioned above and is generally denoted as an “increase error”. The lambda deviation can thereby be expressed in the following manner:

ΔL=⅛_{B}− 1/8_{A}.

8_{A} is thereby the 8 measured in step 23, which in the method shown here by way of example is equal to 1. 8_{B} is the 8 of the exhaust gas measured in step 25. In step 26 an adaptation correction factor is now selected from the lambda deviation ΔL for the currently observed fuel injector 2.1 such that the lambda deviation ΔL becomes 0.

Another option for carrying out the method according to the invention depicted in FIG. 2 is to ascertain and store the fresh air mass flow in step 23. This is denoted a fr_{A}. The altered lambda value is accordingly not measured in step 25 but is awaited until a lambda control of the internal combustion engine has again adjusted to a lambda value of 1. When the lambda value of 1 has now been adjusted, the fresh air mass flow for the trimmed fuel quantity injection is in turn ascertained and stored as fr_{B}. ΔL calculates in this case to

ΔL=fr_{A}/fr_{B}−1.

The adaptation correction in step 26 is also accordingly carried out in this variation of a method according to the invention.

In step 27 following step 26, the counter for the observed fuel injector is increased by 1. In a subsequent step 28, it is queried whether the counter for the fuel injector is already larger than 4. This would thereby mean that all of the fuel injectors 2.1, 2.2, 2.3 and 2.4 have already been observed. In the event it was determined in step 28 that the counter for the fuel injectors is smaller or equal to 4, the method returns to step 23, whereat the lambda value of the exhaust gas of the internal combustion engine is in turn adjusted to 1 for the specific target total fuel quantity. The internal combustion engine is thereby driven with the target total fuel quantity requirement. The internal combustion engine is in turn subsequently driven in step 24 with the same target total fuel quantity requirement, the injection quantity requirement being however trimmed to the individual fuel injectors. During the second cycle of the method of FIG. 2 now being examined, the quantity requirement in step 24 is now trimmed in such a manner that an injector-specific fuel quantity requirement, which is increased by x, is specified for the fuel injector 2.2, i.e. the second fuel injector. The remaining injectors are in turn activated with a fuel quantity requirement reduced by x/3 so that the following trimming model results:

(−x/3, +x, −x/3, −x/3).

An adaptation correction is then in turn carried out in step 26, an adaptation correction factor for the second fuel injector 2.2 being defined during the second cycle. The method of FIG. 2 is repeated until an adaptation correction factor has been ascertained for all of the cylinders. The method subsequently ends in step 29.

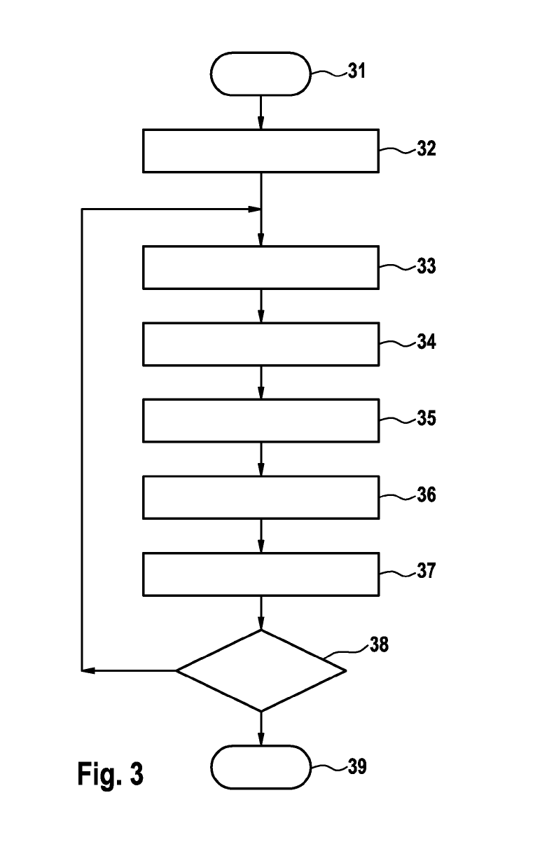

A method according to the invention is likewise schematically depicted in FIG. 3. Because the method of FIG. 3 is similar to that of FIG. 2, reference is therefore additionally made to the description pertaining to the method of FIG. 2. Moreover, the method of FIG. 3 is in turn explained using the arrangement schematically depicted in FIG. 1. In contrast to the method of FIG. 2, the reaction of the fuel injectors to an increased or a reduced fuel quantity requirement is however not checked in the method of FIG. 3. A check is rather made to determine whether the fuel injectors when dividing an injection up into a plurality of individual injections display an error when supplying the required total fuel quantity, respectively the injector-specific fuel quantity required by the respective fuel injector. Such an error is also denoted as an “offset error” in contrast to the “increase error” checked in the method of FIG. 2. The “offset error” is also a measure for how fast a fuel injector reacts to an opening request, i.e. the time lapse between an activation of, for example, the magnetic coil of the fuel injector and the actual opening of the fuel injector.

Steps 31, 32, and 33 of the method of FIG. 3 substantially correspond to steps 21, 22 and 23 of FIG. 2 and are not explained once again. A trimming of the quantity requirement is not carried out in step 34 in contrast to the method of FIG. 2; but the injection quantity of the currently observed fuel injector, i.e. in the first cycle of the method of the fuel injector 2.1, is allocated across two individual injections. The other fuel injectors, i.e. the fuel injectors 2.2, 2.3 and 2.4 of FIG. 1, are likewise activated with one individual injection per operating cycle as in step 33.

Steps 35 and 36 correspond in turn to steps 25 and 26, the adaptation correction factor however correcting an offset parameter in the activation of the observed fuel injector. In turn, it is likewise possible not to use the altered lambda value but rather to ascertain the air mass flow after a lambda adjustment. A further option, which exists in addition to ascertaining the altered lambda value or the altered fresh air mass flow, is to observe the lambda controller during the corrective action after using a trimmed model for injection. A different injected fuel quantity can likewise be suggested from the observed differences in the corrective action by the controller. This also applies equally to all other methods according to the invention.

Steps 37, 38 and 39 in turn substantially correspond to steps 27, 28 and 29 of the method of FIG. 2. It should be pointed out that the methods of FIGS. 2 and 3 in the different configurations described can likewise be used for internal combustion engines having more than or less than four combustion chambers. The methods must therefore only be run through that number of times, which allows for a correction to be undertaken for all of the fuel injectors.

Steps 23 and 33 on the one hand and steps 24, 25 and 34, 35 on the other hand do not have to be implemented immediately one after another. In fact it is possible to also carry out these steps during the operation of the internal combustion engine with a large time delay between them. It is merely necessary for the respective total fuel quantities, the trimmings, the lambda values, respectively the fresh air mass flows, or other ascertained or predetermined parameters and values to be stored in memory. It is also not absolutely necessary to implement the methods according to the invention exactly in the order stated.

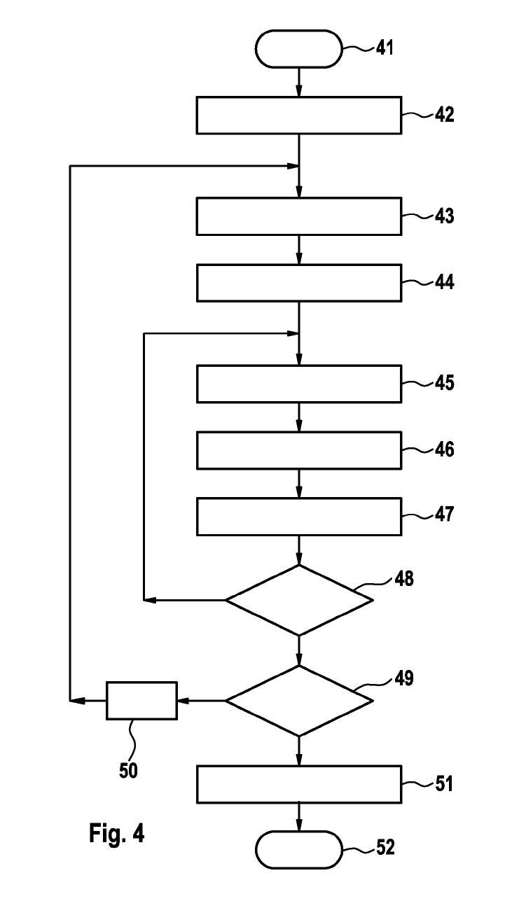

A further embodiment of a method according to the invention is shown in FIG. 4. The method of FIG. 4 fundamentally differs from the methods of FIGS. 2 and 3 by virtue of the fact that a system of equations is created from a plurality of measurements, said system of equations being only then subsequently solved. It is also possible to produce an over-determined system of equations as a result of more than the necessary trimming models being used so that “too many” measured values occur. The advantage in so doing is that an average of a plurality of measurements can be calculated, even at different operating points of the internal combustion engine, by known solution strategies being used for over-determined systems of equations.

The method begins in step 41. In step 42 all variables of the system of equations are set to 0, i.e. the calculation is initialized. In step 43 a first loop of the method begins, wherein a counter for the trimming models to be applied is set to 1.

After that the method of FIG. 4 jumps to step 43. In so doing, a specific target total fuel quantity requirement is given to the valves, all of the fuel injectors being activated with the same injector-specific fuel quantity requirement. The air mass flow is subsequently adjusted such that a lambda value of 1 arises (step 44). This corresponds to a conventional lambda control, wherein, however, a fuel quantity is specified and not a throttle valve position.

In a subsequent step 45, a first trimming model is used in order to activate the fuel injectors with a trimmed fuel quantity requirement. According to the nomenclature described in connection with FIG. 2, the trimming carried out by way of example in the method of FIG. 4 can be expressed as a vector during the first run in the following manner: (+x, −x, +0, +0). During such a trimming, the first fuel injector 2.1 is therefore activated with fuel quantity requirement increased by x and the second fuel injector 2.2 with a fuel quantity requirement decreased by x. The fuel injectors 2.3 and 2.4 are activated without trimming as in step 44.

The lambda value is in turn subsequently measured in step 46 for the trimmed fuel quantity requirement. In the method of FIG. 4, it is also possible as an alternative to wait for the adjustment of the lambda value to 1 by the lambda control and to measure the changed fresh air mass flow. It is thereby to be noted that the lambda value as well as the fresh air mass flow only then appear changed in the event that at least one of the fuel injectors 2.1 and 2.2, which are activated with a trimmed quantity requirement, has an error, for example a gradient error. The values ascertained are stored.

In a subsequent step 47, the counter for the trimming model, respectively for the injection strategy, is increased by 1. A check is made in step 48 to determine whether all of the trimming models have been run through. It should thereby be taken into account that the counter in the method of FIG. 4 does not denote a specific fuel injector but rather a trimming model. Because the untrimmed fuel quantity injection can already be used as an equation for the system of equations, merely three trimmed models are required in order to completely construct the system of equations for the four fuel injectors 2.1, 2.2, 2.3 and 2.4. For that reason a check is made in step 48 to determine whether the method has already been run through for three different trimming models. In the event this is not the case, the method jumps back to step 45. In step 45 the next trimming model is applied to activate the fuel injectors. The second trimming model (+0, +x, −x, +0) and the third trimming model (+0, +0, +x, −x) are in the example described. With the values obtained thereby, a system of equations can be constructed, whose solution yields a vector for correction factors for the four individual fuel injectors.

In the event it is determined in step 48 that all of the trimming models have already been run through, a check is made in step 49 to determine whether still further sets of trimming models are to be used. Provision, for example, is thereby made with the steps 43 to 48 for the method to be run through with still a further set of three other trimming models in order to improve the quality of the system of equations. A further possible set of trimming models is the following: first trimming model: (+x, −x, +x, −x), second trimming model: (+x, +x, −x, −x), third trimming model (+x, −x, −x, −x). Still other additional trimming models are possible beside these. In addition, further trimming models or sets of trimming models are possible for another number of combustion chambers and fuel injectors. The sets of trimming models are in each case simply designed to create a system of equations, with which an individual correction value can be ascertained for each fuel injector. In step 50 the new set of trimming models is initialized.

A check is furthermore preferably made in step 49 to determine whether further measurements (steps 43 to 48) should be taken at another operating point of the internal combustion engine. It can thus be determined in step 49 if any further measurements should be taken at another operating point in order to improve the quality of the adaptation of the activation parameters of the fuel injectors 2.1, 2.2, 2.3 and 2.4. The method would then wait in step 50 until the corresponding operating point is present, or the internal combustion engine is activated so that it works at a desired new operating point.

The system of equations is over-determined with repeated runs of the method. For that reason, known compensating calculation methods are necessary from the technical field in order to ascertain an average value from the individual results, respectively from the equational sentences or parameter sets.

If all of the sets of trimming models or measurements have been processed at different operating points, the method does not then after step 49 jump back over step 50 to step 43 but to a step 51, whereat the system of equations is constructed and solved. Furthermore, an adaptation of the activation of the fuel injectors is carried out with the correction values obtained from the solved system of equations in the event that said adaptation is necessary. The method ends at step 52.

The method of FIG. 4 is likewise applicable for ascertaining the offset error described in connection with FIG. 3. In so doing, sets of injection models are predetermined as different (first, second, etc.) injection strategies, wherein individual injectors are subject to multiple injections and others not at all or are subject to another number of multiple injections. Otherwise the method of FIG. 4 can be analogously applied so that the process for ascertaining an offset error is not described in detail.

1. Method for controlling an internal combustion engine having a plurality of fuel injectors, each for injecting fuel into one combustion chamber of the internal combustion engine, comprising the following steps:
activating the fuel injectors in order to supply a first target total fuel quantity using a first injection strategy,
ascertaining a first actual total fuel quantity injected during the activation using the first injection strategy,
activating the fuel injectors in order to supply a second target total fuel quantity using a second injection strategy, wherein at least one of said fuel injectors is activated differently from said first injection strategy during said second injection strategy,
ascertaining a second actual total fuel quantity injected during the activation using the second injection strategy, and
determining an operating behavior of at least one of the fuel injectors as a function of the first actual total fuel quantity and the second actual fuel quantity.

2. The method according to claim 1, wherein the first target total fuel quantity is the same as the second target total fuel quantity.

3. The method according to claim 1 wherein an operability of the at least one fuel injector is determined as a function of the operating behavior of the fuel injector, which was previously determined.

4. The method according to claim 1, wherein adaptation of an activation parameter for the at least one fuel injector as a function of the operating behavior previously determined.

5. The method according to claim 1, wherein at least two of the fuel injectors having in each case a different injector fuel quantity requirement with respect to the first injection strategy are activated during the second injection strategy.

6. The method according to claim 1, wherein at least one of the fuel injectors having a different number of injector openings with respect to the first injection strategy for one operating cycle of the internal combustion engine is activated during the second injection strategy.

7. The method according to claim 1, wherein evaluating a signal of a lambda probe of the internal combustion engine in order to ascertain the actual total fuel quantities.

8. The method according to claim 1, wherein a plurality of activations using the first injection strategy and/or the second injection strategy occurs in each case at different operating points of the internal combustion engine.

9. Device, particularly a control unit or an internal combustion engine, which is equipped for carrying out a method according to claim 1.

10. Computer program with program code for carrying out all of the steps according to claim 1 if the program is executed on a computer.
